(19) United States
(12) Patent Application Publication
(10) Pub. No.: US 2003/0175412 A1
(43) Pub. Date: Sep. 18, 2003

(54) Method and arrangement for the production of a thin layered structure

(76) Inventors: K O Kai Bar, Bruckmuhl (DE); Rainer Gaus, Bruckmuhl (DE)

Correspondence Address: VENABLE, BAETJER, HOWARD AND CIVILETTI, LLP, P.O. BOX 34385, WASHINGTON, DC, 20043-9998, US

(21) Appl. No.: 10/275,725

(22) PCT Filed: May 8, 2001
(86) PCT No.: PCT/EP01/05228

(30) Foreign Application Priority Data
May 8, 2000 (DE) 100-22-223.4
May 19, 2000 (DE) 1--=24=731.8

(51) Int. Cl. B05D 5/12

(52) U.S. Cl. 427/58; 427/508; 118/620

(57) ABSTRACT

Method of producing a thin laminated construction from a carrier in the form of a flexible, in particular quasi-endless band, with at least one functional coating that is firmly bonded to the carrier and has a thickness in particular of the same order of magnitude as the thickness of the carrier, with the steps:

formation of an initial layer structure by applying an original coating material to the carrier over a large area, and

irradiation of the carrier bearing the original coating material with electromagnetic radiation that has an effective component in the near-infrared region, to form the functional coating from the original coating material and simultaneously bond it to the carrier with the inclusion of drying and/or thermal cross-linking.

### DESCRIPTION

The invention relates to a method of producing a thin laminated construction according to the precharacterizing clause of claim 1, as well as to an apparatus for implementing this method.

Structures consisting of thin layers supported on large-area, thin carriers are becoming increasingly important in various areas of technology. Known and economically highly significant examples include thin-layer transistor structures, such as are employed in particular in liquid-crystal display arrangements, and other thin-layer systems for display units such as plasma displays. Additional thin-layer devices that are both technically and economically significant are the separator structures of electrochemical elements, in particular primary or secondary elements based on lithium (lithium batteries and lithium-ion accumulators, etc.) as well as highly differentiated membrane systems for separating substances and obtaining energy, for instance fuel cells.

To produce such thin-layer systems, it is ordinarily necessary for a thin coating in an initial state, following application to a thin carrier, to be converted to a functional layer and firmly bonded to the carrier. The aim here is that the process should be carried out with high reliability, excluding all possibility of damage to the carrier or the coating material, and with high productivity, i.e. a high throughput in terms of unit area per unit time.

For the various thin-layer systems of this generic kind that are currently of great technological importance, various kinds of manufacturing procedures are known, but they do not entirely satisfy these demands.

The objective of the invention is thus to disclose an improved method of this generic kind that is nearly universally applicable, can easily be adapted to diverse specific layer structures, and is characterized by potentially high productivity, simplicity and reliability while largely excluding damage to the coating(s) and/or to the carrier.

This objective is achieved by a method with the characteristics given in claim 1. A useful apparatus to implement this method is disclosed in claim 17.

The invention incorporates the fundamental idea that the original coating material applied in each case is converted into the functional layer of the laminated construction, and simultaneously bonded to the carrier, by applying electromagnetic radiation in the near-infrared (NIR) region, i.e. the wavelength region between 0.8 and 1.5 μm, to the continuously transported product. The effect thereby achieved—to different degrees, depending on the specific layer system—is in particular a drying and/or cross-linkage of the original coating material, in many cases combined with melting and hence fusion to the carrier.

The radiation employed in accordance with the invention can be produced in a simple and economical way by operating a high-power halogen lamp at an elevated temperature.

In preferred laminated constructions both the original coating material and the carrier have an intermediate thickness in the range between 5 μm and 500 μm, in particular between 20 μm and 200 μm.

Materials used as the carrier in important applications are in particular various plastic films, especially PE, PP or PVC films, or metal foils or fine woven fabrics made of metal, especially aluminum or copper or their alloys. The original coating material is in particular applied in liquid or pasty form, or else as a powder, by means of suitable coating techniques known per se, preferably being spun, rolled, sprayed, sprinkled or blown onto the carrier.

The spectral composition of the infrared radiation used for processing is adjusted in accordance with the absorption properties of the original coating material, preferably in such a way that the material is heated substantially uniformly over the thickness of the layer, so as to avoid imposing an unacceptable thermal stress on the carrier or on individual regions of the coating. This adjustment can be carried out by way of the operating voltage; furthermore, filters can be inserted. The adjustment of strength of the incident radiation can be accomplished in particular by varying the distance between the radiation source and the surface of the layered structure. The radiation can be sent directly into the coating or through the carrier or be applied from both sides.

By means of a stream of gas that passes over the surface of the applied original coating material and/or the back surface of the carrier (for which in many cases of application an airstream suffices), it is possible on one hand to make the temperature distribution more uniform and, where desired, to reduce the surface temperature, while on the other hand volatile components of the original coating material can rapidly be removed. As a result, the reliability and efficiency of the method can be further increased. The flowing gas (air) is preferably dry and cold and is applied with high pressure or impetus.

In a further refinement of the method a means of regulating performance based on feedback of detector signals (e.g., from temperature sensors) is provided.

The proposed method is suitable for manufacturing thin-layer transistor arrangements, in particular liquid-crystal display arrangements, and separator membranes for electrochemical elements, in particular lithium-ion accumulators, as well as for manufacturing thin-layer structures for plasma displays and membrane structures for fuel cells.

A preferred apparatus for implementing the method comprises the following: a delivery and forward-feed device suitable for handling a quasi-endless carrier, which in particular can consist of a supply roll of the carrier material and a forward-feed mechanism employing rollers; a delivery and layer producing device to deliver the original coating material and apply it to the carrier surface so as to form a layer; and the NIR irradiation device, which in particular consists of one or more halogen lamps with a large spectral component in the NIR plus an appropriate power supply.

In preferred embodiments of this apparatus there is additionally provided a flow-generating device to produce and direct the above-mentioned gas stream and/or a device for adjusting or regulating the strength of the incident radiation, the latter preferably comprising means for altering the distance between the radiation source and layered structure.

The implementation of the invention is not restricted to the particular applications and aspects described above but is also possible in a large number of further applications and with additional aspects, the discovery of which is within the competence of those skilled in the art.

1. Method of producing a thin laminated construction from a carrier in the form of a flexible, in particular quasi-endless band, with at least one functional coating that is firmly bonded to the carrier and has a thickness in particular of the same order of magnitude as the thickness of the carrier, characterized by the steps:
formation of an initial layer structure by applying an original coating material to the carrier over a large area, and
irradiation of the carrier bearing the original coating material with electromagnetic radiation that has an effective component in the near-infrared region, to form the functional coating from the original coating material and simultaneously bond it to the carrier with the inclusion of drying and/or thermal cross-linking.

2. Method according to claim 1, characterized in that the radiation from a halogen lamp operated at an elevated operating temperature is employed.

3. Method according to claim 1 or 2, characterized in that the original coating material, with a mean thickness in the range between 5 μm and 500 μm, in particular between 20 μm and 200 μm, is applied to a carrier with a mean thickness in the range between 5 μm and 500 μm, in particular between 20 μm and 200 μm.

4. Method according to one of the preceding claims, characterized in that as carrier a plastic film, in particular polyethylene, polypropylene or PVC film is employed.

5. Method according to one of the claims 1 to 3, characterized in that as carrier a thin metal foil or a fine woven fabric made of metal, in particular aluminum or copper or an aluminum- or copper-containing alloy, is employed.

6. Method according to one of the preceding claims, characterized in that the original coating material is applied in liquid or pasty form, in particular is spun, rolled or sprayed onto the carrier.

7. Method according to one of the claims 1 to 5, characterized in that the original coating material is applied in powder form, in particular is sprinkled or blown onto the carrier.

8. Method according to one of the preceding claims, characterized in that the spectral composition of the radiation is adjusted in accordance with the absorption properties of the original coating material and, if desired, those of the carrier, in such a way that the original coating material is heated substantially uniformly through the entire thickness of the layer.

9. Method according to claim 8, characterized in that the spectral composition is adjusted by means of at least one filter.

10. Method according to one of the preceding claims, characterized in that to adjust the strength of the incident radiation, the distance between the radiation source and the surface of the original coating material is varied.

11. Method according to one of the preceding claims, characterized in that a stream of gas, in particular an airstream, is passed over the surface of the original coating material and/or the back surface of the carrier for the purpose of cooling and/or removal of volatile components of the original coating material.

12. Method according to claim 11, characterized in that a dry, cold gas is delivered with high impetus.

13. Method according to one of the preceding claims, characterized in that a carrier is provided with a functional coating to produce a thin-layer transistor arrangement, in particular for a liquid-crystal display arrangement.

14. Method according to one of the claims 1 to 12, characterized in that a carrier is provided with a functional coating to produce a separator membrane for an electrochemical element, in particular a lithium-ion accumulator.

15. Method according to one of the claims 1 to 12, characterized in that a carrier is provided with a functional coating to produce a thin-layer structure for a plasma-display arrangement.

16. Method according to one of the claims 1 to 12, characterized in that a carrier is provided with a functional coating to produce membrane structure for a fuel cell.

17. Apparatus for producing a thin laminated construction from a carrier in the form of a flexible, in particular quasi-endless band, with at least one functional coating that is firmly bonded to the carrier and has a thickness in particular of the same order of magnitude as the thickness of the carrier, with the steps:
formation of an initial layer structure by applying an original coating material to the carrier over a large area, and
irradiation of the carrier bearing the original coating material with electromagnetic radiation that has an effective component in the near-infrared region, to form the functional coating from the original coating material and simultaneously bond it to the carrier with the inclusion of drying and/or thermal cross-linking, with:
a delivery and forward-feed device for the carrier,
a delivery and layer-producing device for the, in particular continuous, delivery of the original coating material and application thereof to the carrier, and
an irradiation device disposed downstream of the delivery and layer-producing device, which generates radiation that is directed toward the carrier provided with the original coating material and that has an effective component in the near-infrared region.

18. Apparatus according to claim 17, characterized in that the irradiation device is constructed as a halogen lamp, in particular one that is operated at an elevated operating temperature.

19. Apparatus according to claim 17 or 18, characterized by a flow-generating device to produce a stream of gas that is directed substantially parallel to the surface of the laminated construction or the initial layer structure and passes over said structure in the region in which the action of the irradiation device is exerted, in particular a stream of dry, cold gas with high impetus.

20. Apparatus according to one of the preceding claims, characterized by means for adjusting the strength of the incident radiation, in particular positioning means for high-precision adjustment of the position of at least one radiation source in the irradiation device.

21. Apparatus according to one of the claims 17 to 20, characterized by a regulation device to regulate the strength of the radiation from the irradiation device.
